(19) United States
(12) Patent Application Publication
(10) Pub. No.: US 2006/0132308 A1
(43) Pub. Date: Jun. 22, 2006

(54) Lost item locater

(76) Inventors: Lori Elizabeth Stump, Cement City, MI (US); Lawrence Ferri, Cement City, MI (US)

Correspondence Address: Lori Stump, 10901 Briggs Hwy, Cement City, MI, 49233, US

(21) Appl. No.: 11/002,919

(22) Filed: Dec. 3, 2004

(51) Int. Cl. G08B 13/14

(52) U.S. Cl. 340/572.1

(57) ABSTRACT

1. A system for locating lost items such as remote controls, eye glasses, car keys and any other house hold items using a RFID passive transponder (uhf tag) and a portable reader transceiver. This will allow people to find any item they have a RFID tag on using the transceiver. 2. The system of claim 1 wherein the transponder has an adhesive backing that will enable placement. 3. The system of claim 1 wherein the transceiver will have a LCD screen that will allow you to enter the tag number and the item the RFID tag in placed on. 4. The system of claim 1 wherein the transceiver will have a base that will recharge the battery and also the base will have a call button in case the transceiver is misplaced. 5. The system of claim 1 will include a pack of 10 RFID tags and one transceiver and one base. A radio frequency identification devise with modifications, will allow the person to locate their lost item within six to eight feet from the lost item by emitting a signal from the transceiver.

### BACKGROUND OF THE INVENTION

1. Field of the Invention

This invention is related to lost items and to an apparatus and method for locating lost items. This invention is also related to a signaling device that can be adhered to any item and to a detector for locating the signaling device, attached to the lost item within a certain area.

2. Description of the Prior Art

Households sometimes suffer from forgetfulness and frequently have difficulty remembering where they put things. Sometimes if there are small children in the household they tend to hide the tv remote, keys, eye glasses and many other items. The RFID transponder (uhf tag) and the receiver will help find the misplaced item.

### SUMMARY OF THE INVENTION

A system to find lost items using a RFID passive transponder (uhf tag) and a hand held transceiver. The RFID tags (uhf tags) will have an adhesive backing to place on the item. The system will include 10 RFID tags (uhf tags) and a rechargeable transceiver with a base and a call button to locate the transceiver in case it is misplaced.

The passive transponder can be adhered on any item. The item with a passive RF transponder (uhf tag) can then be used in a system for locating the lost item. The RF passive transponder will be identified by a transceiver with a LCD screen to identify the item lost within a localized area.

We claim:

1. A system for locating lost items such as remote controls, eye glasses, car keys and any other house hold items using a RFID passive transponder (uhf tag) and a portable reader transceiver. This will allow people to find any item they have a RFID tag on by using the transceiver.

2. The system of claim 1 wherein the transponder has an adhesive backing that will enable placement.

3. The system of claim 1 wherein the transceiver will have a LCD screen that will allow you to enter the tag number and the item the RFID tag in placed on.

4. The system of claim 1 wherein the transceiver will have a base that will recharge the battery and also the base will have a call button in case the transceiver is misplaced.

5. The system of claim 1 will include a pack of ten RFID tags (uhf tags) and one transceiver and one base.
A radio frequency identification devise with modifications, will allow the person to locate their lost item within six to eight feet from the lost item by emitting a signal from the transceiver.
